(19) United States
(12) Patent Application Publication
(10) Pub. No.: US 2006/0184732 A1
(43) Pub. Date: Aug. 17, 2006

(54) Disk device control program, disk device control method and disk device control system

(75) Inventor: Yoshinori Ito, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 11/119,784

(22) Filed: May 3, 2005

(30) Foreign Application Priority Data
Feb. 14, 2005 (JP) 2005-035825

(51) Int. Cl. G06F 12/14

(52) U.S. Cl. 711/114

(57) ABSTRACT

A disk device control program, a disk device control method, and a disk device control system which can build a disk device having a plurality of disk units and facilitate the preventive replacement of the disk device are provided. A disk device control program for allowing a computer to execute a disk device control method for controlling a disk device having a plurality of disk units, and a disk unit controller for forming disk groups and performing a copy state between the disk groups, allows a computer to execute a disk group forming step S11 that allows the disk unit controller to form a plurality of disk groups, a copy state starting step S12 that allows the disk unit controller to start a copy state between the plurality of disk groups, and a disk group setting step S16 that sets the plurality of disk groups.

### BACKGROUND OF THE INVENTION

1. Field of the Invention

The present invention relates to a disk device control program, a disk device control method and a disk device control system for controlling a disk device having a plurality of disk units.

2. Description of Related Art

In a large-scale information processor, such as a recent server, etc., RAID (Redundant Array of Inexpensive Disks) which achieves high-speed process, high reliability, and high fault resistance by dividing data and reading and writing the data in parallel with a plurality of disk units is used.

Here, three cases in a disk device using a conventional RAID will be described.

First, as the first case, a case that soft mirroring is built will be described. FIG. 9 is a block diagram showing one example of a structure of a disk device control system in a conventional first case. This disk device control system has a disk device 111, and a host server 161. The disk device 111 has disk units 21a, 21b, 21c, and 21d, a disk unit interface 31, a disk unit controller 141, and a host interface 51. The host server 161 has a disk device interface 71, and a disk device controller 181.

The disk device controller 181 is connected to the disk device 111 through the disk device interface 71 and gives a designation to the disk device 111. The disk unit controller 141 is connected to the disk units 21a, 21b, 21c and 21d through the disk unit interface 31, and connected to the host server 161 through the host interface 51. Also, the disk unit controller 141 controls the disk units 21a, 21b, 21c and 21d according to the designation from the host server 161.

Then, in this disk unit 111, an operation for forming soft mirroring will be described. First, a manager sets an RAID group x using the disk units 21a, 21b and an RAID group y using the disk units 21c and 21d from the disk device controller 181 to the disk unit controller 141. The manager writes data to the RAID group x by using the disk device controller 181. Subsequently, the manager copies the data from the RAID group x to the RAID group y by using the disk device controller 181. Then, the manager sets a new RAID group a that is soft-mirrored RAID groups x and y by using a soft mirroring driver in the disk device controller 181.

Thus, the disk device 111 in which the two RAID groups x and y are used as soft mirroring, can be built.

Then, as the second case, a case that a plurality of same boot environments for a plurality of host servers are formed, will be described. FIG. 10 is a block diagram showing one example of a structure of a disk device control system in a conventional second case. In FIG. 10, the same reference numbers as those in FIG. 9 indicate the same as or equivalents to those shown in FIG. 9, and their description will be omitted. As compared with the disk device control system of FIG. 9, a disk device control system of FIG. 10 has host servers 161a and 161b similar to a host server 161 instead of the host server 161. The disk device 111 is connected to the host servers 161a and 161b. Also, the disk unit controller 141 controls the disk units 21a, 21b, 21c and 21d according to the designation from the host server 161a or the host server 161b.

Then, in this disk device 111, an operation for forming boot environments of a plurality of host servers will be described. First, the manager sets disk units 21a and 21b as the RAID group x used by the host server 161a from the host server 161a or the host server 161b to the disk unit controller 141, and sets the disk units 21c and 21d as the RAID group y used by the host server 161b. Then, the manager installs OS (Operating Systems) used by the host server 161a to the RAID group x by using the host server 161a. Then, similarly, the manager installs OS used by the host server 161b to the RAID group y by using the host server 161b.

Thus, the boot environments of the host server 161a and the host server 161b can be built in the disk device 111.

Then, as the third case, a case that a disk unit is preventively replaced, will be described. FIG. 11 is a block diagram showing one example of a structure of a disk device control system in a conventional third case. In FIG. 11, the same reference numerals as those in FIG. 9 indicate the same as or equivalent to objects shown in FIG. 9, and the description thereof will be omitted. Also, when compared with the disk device control system of FIG. 9, a disk device control system of FIG. 11 has a disk device 113 instead of the disk device 111, and newly has disk units 21e and 21f, and a hot spare disk device 20. As compared with the disk device 111, the disk device 113 does not need disk units 21c and 21d. The disk units 21e and 21f are disk units prepared for replacements of the disk units 21a and 21b. The hot spare disk device 20 is a disk device connectable to the disk device interface 71.

Then, in this disk device 113, an operation for preventively replacing disk units will be described. Here, it is noted that the disk units 21a and 21b are set as a RAID group x. First, the manager copies data of the disk unit 21a to the hot spare disk device 20 by using the host server 161. Then, the manager replaces the disk unit 21a to the disk unit 21e. Then, the manager copies the data of the hot spare disk device 20 to the disk unit 21e by using the host server 161. Similarly, the data of the disk unit 21b is copied to the hot spare disk device 20, the disk unit 21b is replaced by the disk unit 21f, and the data of the hot spare disk device 20 is copied to the disk unit 21f. The manager allows the disk units 21e and 21f to be used as the RAID group x similarly to the disk units 21a and 21b before replacement.

Thus, the disk units used for the RAID group can be preventively replaced.

However, in the first case, since it is necessary to copy data from the RAID group x to the RAID group y by using the host server, a load is applied to the host server to affect its operation, and it takes time to copy the data. Further, in the second case, since it is necessary to install the OS at each host server, it takes effort and time. In addition, in the third case, for one disk unit, it is necessary to copy data to the hot spare disk device, to replace the disk unit, and to copy data from the hot spare disk device, and since it is further necessary to repeat these operations for all these disk units, it takes labor and time, and has a large risk.

### SUMMARY OF THE INVENTION

The present invention has been made to solve the above-mentioned problems, and has an object of providing a disk device control program, a disk device control method, and a disk device control system which can build a disk device having a plurality of disk units and facilitate the preventive replacement.

To solve the afore-mentioned problems, the present invention provides a disk device control program for allowing a computer to execute a disk device control method for controlling a disk device having a plurality of disk units, and a disk unit controller for forming disk groups having at least one disk unit according to a designation from an external unit and performing a copy state between the disk groups, the program comprising: a disk group forming step that allows form the disk unit controller to form a plurality of disk groups; a copy state starting step that allows the disk unit controller to start a copy state between the plurality of disk groups; and a disk group setting step that sets the plurality of the disk groups.

In the disk device control program according to the present invention, the disk groups are RAID groups for applying RAID to the constituent disk unit.

In the disk device control program according to the present invention, the copy state starting step starts an equivalent state to copy so that the disk group of the copying destination is equivalent to the disk group of the copying source as the copy state. Further, the program allows a computer to execute a data building step that builds data in the disk group of the copying source in the equivalent state between the copy state starting step and the disk group setting step, and a copy state ending step that allows the disk unit controller to end the equivalent state after completion of copying in the equivalent state. The disk group setting step sets mirroring using the plurality of disk groups as the setting.

In the disk device control program according to the present invention, the copy state starting step starts an equivalent state to copy so that the disk group of the copying destination is equivalent to the disk group of the copying source. Further, the program allows a computer to execute a boot environment building step that builds a boot environment in the disk group of the copying destination in the equivalent state between the copy state starting step and the disk group setting step, and a copy state ending step that allows the disk unit controller to end the equivalent state after completion of copying in the equivalent state. The disk group setting step performs setting for a plurality of external hosts to independently use the plurality of disk groups.

In the disk device control program according to the present invention, the disk group forming step allows the disk unit controller to form: a disk group in use that is a disk group of disk unit in use, a replacement disk group that is a disk group of a replacement disk unit when the replacement disk unit is connected to the disk unit controller. The copy state starting step allows the disk unit controller to start an equivalent state, as the copy state, which copies so that a copying destination that is the replacement disk group is equivalent to a copying source that is the disk group in use. Further, the program allows a computer to execute a copy state ending step that allows disk unit controller to end the equivalent state after completion of copying in the equivalent state between the copy state starting step and the disk group setting step. The disk group setting step sets to use the replacement disk group as the setting.

The disk device control program according to the present invention allows a computer to execute, a boot environment building step that builds a boot environment in one disk group of the plurality of disk groups between the disk group forming step and the copy state starting step. The copy state starting step starts copying of data in other disk group from the disk group in which the boot environment is built by the boot environment building step as the copy state, and the disk group setting step sets to allow a plurality of external hosts to independently use the plurality of disk groups as the setting after the copy is completed.

In the disk device control program according to the present invention, the disk group forming step allows the disk unit controller to form: a disk group in use that is a disk group of disk unit in use; a replacement disk group that is a disk group of replacement disk unit when the replacement disk unit is connected to the disk unit controller. The copy state staring step stars copying of data in the replacement disk group from the disk group in use as the copy state. The disk group setting step sets for using the replacement disk group as the setting after the copy is completed.

The present invention is a disk device control method for controlling a disk device having a plurality of disk units, and a disk unit controller for forming disk groups having at least one disk unit according to an external designation and performing a copy state between the disk groups, the method comprising: a disk group forming step that allows the disk unit controller to form a plurality of disk groups; a copy state starting step that allows the disk unit controller to start a copy state between the plurality of disk groups; and a disk group setting step that set the plurality of disk groups.

The present invention is a disk device control system for controlling a plurality of disk devices, the system comprising: a plurality of disk units; a disk unit controller for forming disk groups having at least one disk unit according to an external designation and performing a copy state between the disk groups; and a disk device controller for allowing the disk unit controller to form a plurality of disk groups and to start a copy state between the plurality of disk groups, and setting the plurality of disk groups.

In the disk device control system according to the present invention, the disk groups are RAID groups for applying RAID to the constituent disk unit.

In the disk device control system according to the present invention, the disk device controller starts an equivalent state to copy so that the disk group of the copying destination is equivalent to the disk group of the copying source as the copy state, further, builds data in the disk group of the copying source in the equivalent state, allows the disk unit controller to end the equivalent state after the copy is completed in the equivalent state, and sets mirroring using the plurality of disk groups as the setting.

In the disk device control system according to the present invention, the disk device controller starts an equivalent state to copy so that the disk group of the copying destination is equivalent to the disk group of the copying source as the copy state, further, builds a boot environment in the disk group of the copying source in the equivalent state, allows the disk unit controller to end the equivalent state after the copy is completed in the equivalent state, and sets for a plurality of external hosts to use independently the plurality of disk groups as the setting.

In the disk device control system according to the present invention, the disk device allows the disk unit controller: to form a disk group in use that is a disk group of disk unit in use as the disk group; to form a replacement disk group that is a disk group of replacement disk unit when the replacement disk unit is connected to the disk unit controller; to start an equivalent state which copies so that a copying destination that is the replacement disk unit is equivalent to a copying source that is the disk group in use as the copy state; and to end the equivalent state after the copy is completed in the equivalent state, and as the setting, sets to use the replacement disk group.

In the disk device control system according to the present invention, the disk device controller forms the disk group, then builds a boot environment in one disk group of the plurality of disk groups, as the copy state, starts copying of data in the other disk group from the disk group in which the boot environment is built in the boot environment building step, and after the copy is completed, as the setting, sets for a plurality of external hosts to independently use the plurality of disk groups.

In the disk control device control system according to the present invention, the disk device controller allows the disk unit controller to form a disk group in use that is a disk group of disk unit in use as the disk group and to form a replacement disk group that is a disk group of replacement disk unit when the replacement disk unit is connected to the disk unit controller, starts copying of data in the replacement disk group from the disk group in use, and sets, after the copy is completed, as the setting, to use the replacement disk group.

According to the present invention, when the disk device using a plurality of RAID groups in mirroring is built, an equivalent copying function by a hardware is used, but a host server is not used. Therefore, a copying time can be shortened, and a load to the host server can be reduced. Further, when the same boot environments are built in a plurality of the host servers, installing of the OS requires only one action. As compared with the case that the OS is installed in each host server as the prior art, it can reduce labor and time. Also, when a plurality of disk units are preventively replaced, a plurality of new disk units are mounted at once, copying is performed at once, and a plurality of old disk units are removed at once. Thus, labor, time and risk can be remarkably reduced. Further, the hot spare disk device which has been needed in the conventional preventive replacement is not required.

### BRIEF DESCRIPTION OF THE DRAWINGS

FIG. 1 is a block diagram showing one example of a structure of a disk device control system for the first case according to the present invention;

FIG. 2 is a flowchart showing one example of an operation of a disk device controller for the first case according to the present invention;

FIG. 3 is a block diagram showing one example of a structure of a disk device control system for the second case according to the present invention;

FIG. 4 is a flowchart showing one example of an operation of a disk device controller for the second case according to the present invention;

FIG. 5 is a block diagram showing one example of a structure of a first state of a disk device control system for the third case according to the present invention;

FIG. 6 is a flowchart showing one example of an operation of a disk device controller for the third case according to the present invention;

FIG. 7 is a block diagram showing one example of a structure of a second state of a disk device control system for the third case according to the present invention;

FIG. 8 is a block diagram showing one example of a structure of a third state of a disk device control system for the third case according to the present invention;

FIG. 9 is a block diagram showing one example of a structure of a disk device control system in a conventional first case;

FIG. 10 is a block diagram showing one example of a structure of a disk device control system in a conventional second case; and

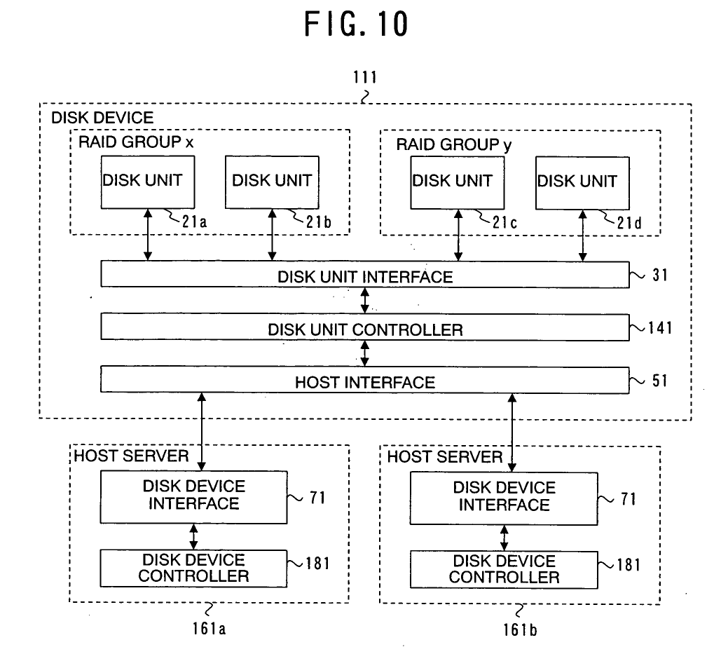

FIG. 11 is a block diagram showing one example of a structure of a disk device control system in a conventional third case.

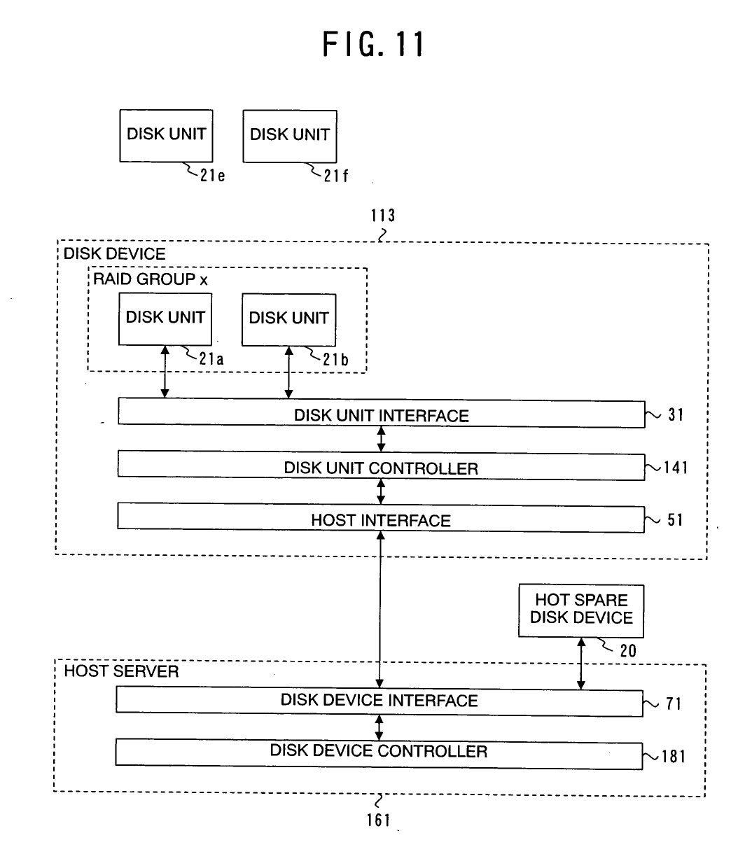

### DETAILED DESCRIPTION OF THE PREFERRED EMBODIMENTS

In the following, embodiments of the present invention will be described in detail with reference to accompanying drawings.

### Embodiment 1

In this embodiment, a disk device control system for the above-mentioned first case will be described.

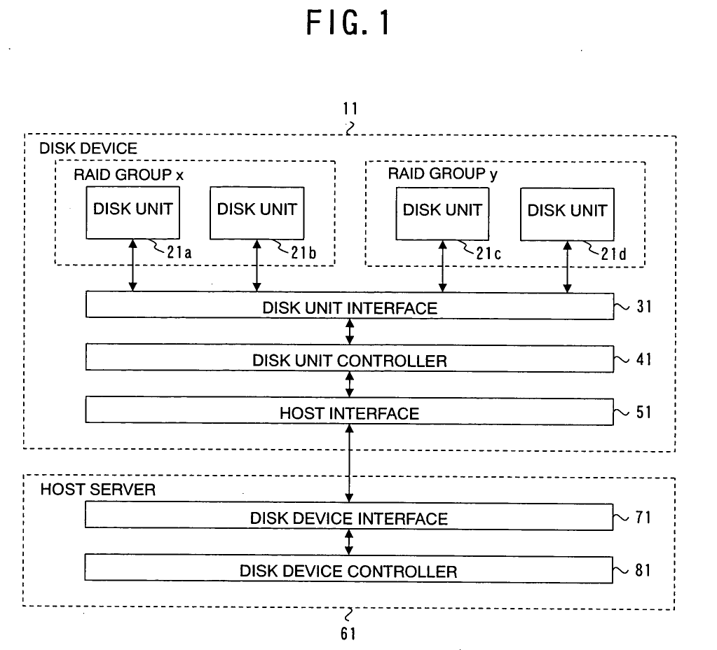

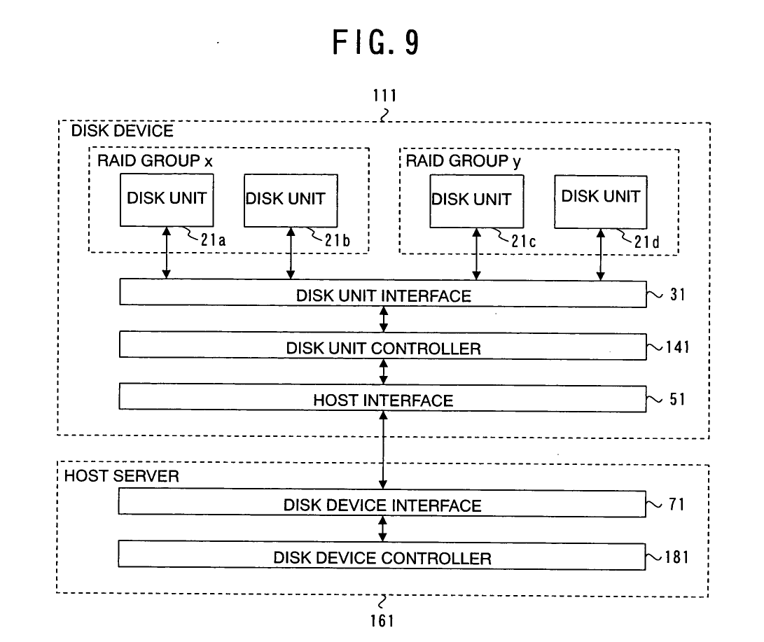

First, a structure of the disk device control system for the first case will be described. FIG. 1 is a block diagram showing one example of a structure of a disk device control system for the first case according to the present invention. In FIG. 1, the same reference numerals as those in FIG. 1 indicate the same as or equivalence to the object shown in FIG. 9, and the description thereof will be omitted here. As compared with the disk device control system of FIG. 9, the disk device control system of FIG. 1 has a disk device 11 instead of the disk device 111, and has a host server 61 instead of the host server 161. As compared with the disk device 111, the disk device 11 has a disk unit controller 41 instead of the disk unit controller 141. As compared with the host server 161, the host server 61 has a disk device controller 81 instead of the disk device controller 181.

The disk device controller 81 gives a designation to the disk device 11. The disk unit controller 41 controls the disk units 21a, 21b, 21c and 21d according to the designation from the host server 61.

The disk unit controller 41 has an equivalent copying function which is realized, for example, by a RAID controller, an intellectualized switch, etc., and which equalizes the RAID group of a copying destination to the RAID group of a copying source. The equivalent copying function doubles two RAID groups when the equivalent state is started by a designation from the host server 61, and the two RAID groups can be used as independent RAID groups when the equivalent state is ended by the designation from the host server 61. Also, during copying, updating to the copying destination is rejected, and updating to the copying source is reflected to the copying destination. Further, the disk device controller 81 has a soft mirroring driver for realizing mirroring by a software.

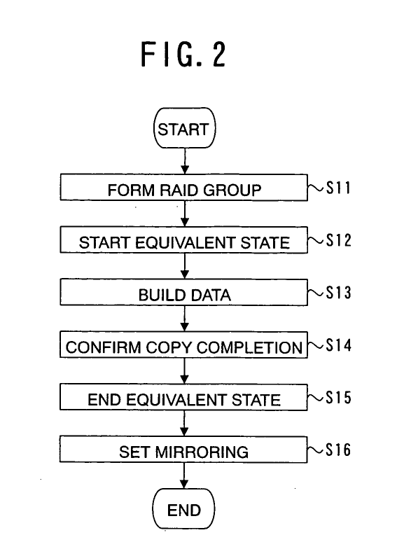

Then, an operation of the disk device controller 81 for the first case will be described. FIG. 2 is a flowchart showing one example of an operation of the disk device controller for the first case according to the present invention. First, the disk device controller 81 designates the disk unit controller 41, and forms a RAID group x having disk units 21a and 21b, and a RAID group y having disk units 21c and 21d (S11). Then, the disk device controller 81 designates the disk unit controller 41, and starts an equivalent state so that the RAID group y becomes equivalent to the RAID group x by using equivalent copying function of the disk unit controller 41 (S12). The disk device controller 81 builds data in the RAID group x (S13). Then, when the disk device controller 81 confirms the completion of copying (S14), the disk unit controller 81 designates the disk unit controller 41, and finishes the equivalent state (S15). Then, the disk device controller 81 sets a RAID group a using the RAID groups x and y as mirroring by the soft mirroring driver (S16). Thereafter, the host server 61 can utilize the RAID group a.

According to this embodiment, the disk device using a plurality of the RAID groups for the mirroring can be built. Further, since the copy from the RAID group x to the RAID group y uses the equivalent copying function by the hardware of the disk unit controller 41 but does not use the host server, the copying time can be reduced, and the load to the host server can be reduced.

Incidentally, in the above-mentioned description, the number of the disk units in the RAID group x and the RAID group y are two, but three or more may be used, or one disk unit may be sufficient instead of the RAID groups.

### Embodiment 2

In this embodiment, the disk device control system for the above-mentioned second case will be described.

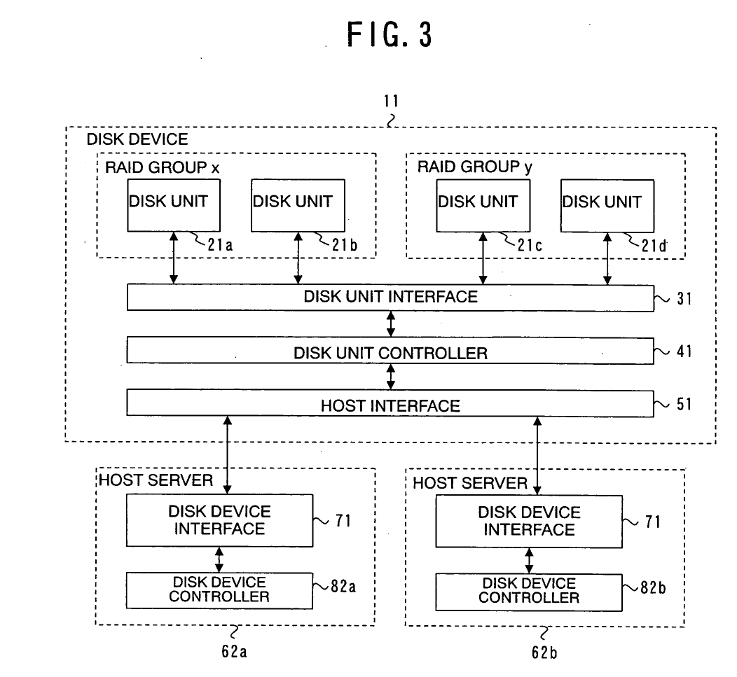

First, a structure of the disk device control system for the second case will be described. FIG. 3 is a block diagram showing one example of a structure of a disk device control system for the second case according to the present invention. In FIG. 3, the same reference numerals as those in FIG. 1 indicate the same as or equivalent to objects shown in FIG. 1, and the description thereof will be omitted here. As compared with the disk device control system of FIG. 1, the disk device control system of FIG. 3 has host servers 62a and 62b instead of the host server 61. As compared with the host server 61, the host servers 62a and 62b have disk device controllers 82a and 82b instead of the disk device controller 81. The disk device controllers 82a and 82b give designations to the disk device 11.

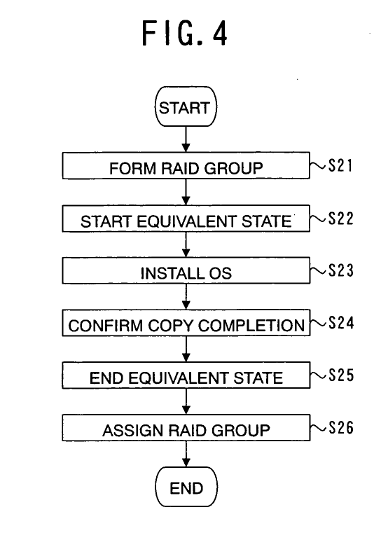

Then, an operation of the disk device controller 82a for the second case will be described. FIG. 4 is a flowchart showing one example of an operation of a disk device controller for the second case according to the present invention.

First, the disk device controller 82a designates the disk unit controller 41, and forms a RAID group x having disk units 21a and 21b and a RAID group y having disk units 21c and 21d (S21). Then, the disk device controller 82a designates the disk unit controller 41, and starts an equivalent state so that the RAID group y becomes equivalent to the RAID group x by using the equivalent copying function (S22). Then, the disk device controller 82a installs OS in the RAID group x (S23). Then, when the disk device controller 82a confirms the completion of copying (S24), the disk device controller 82a designates the disk unit controller 41, and ends the equivalent state (S25). Then, the disk device controller 82a designates the disk unit controller 41, assigns that the host server 62a uses the RAID group x, and assigns that the host server 62b uses the RAID group y (S26). Thereafter, the host server 62a can boot by using the RAID group x of the disk device 11, and the host server 62b can boot by using the RAID group y of the disk device 11.

According to this embodiment, when the same boot environment is built in a plurality of the host servers, installing of the OS requires only one action. Thus, as compared with the conventional case of installing the OS at each host server, it can reduce labor and time.

Incidentally, the numbers of the disk units in the RAID group x and the RAID group y are set two. However, three or more may be used. Instead of the RAID group, one disk unit may be used. In this embodiment, the example in which two sets, each having the host server and the RAID group, has been described. However, three sets or more may be applied.

In copying from the RAID group x to the RAID group y, an instantaneous copying function may be used instead of the equivalent copying function. In this case, the disk unit controller 41 has an instantaneous copying function of copying the instantaneous data of the RAID group of the copying source in the RAID group of the copying destination.

### Embodiment 3

In this embodiment, the disk device control system for the above-mentioned third case will be described.

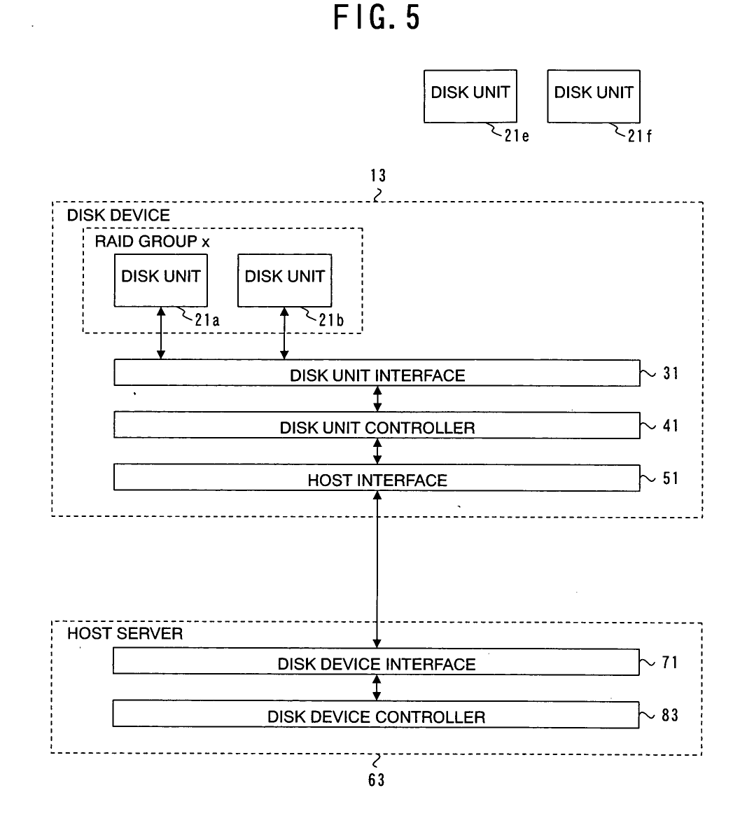

First, a structure of an initial state of a disk device control system for the third case will be described. FIG. 5 is a block diagram showing one example of a structure of the first state of the disk device control system for the third case according to the present invention. In FIG. 3, the same reference numerals as those in FIG. 1 indicate the same as or equivalent to those shown in FIG. 1, and the description thereof will be omitted. When compared with the disk device control system of FIG. 1, the disk device control system of FIG. 5 has a disk device 13 instead of the disk device 11, has a host server 63 instead of the host server 61, and newly has disk units 21e and 21f. As compared with the disk device 11, the disk device 13 does not need the disk units 21c and 21d. As compared with the host server 61, the host server 63 has a disk device controller 83 instead of the host device controller 81. The disk device controller 83 gives a designation to the disk device 13. The disk units 21e and 21f are prepared to replaced the disk units 21a and 21b.

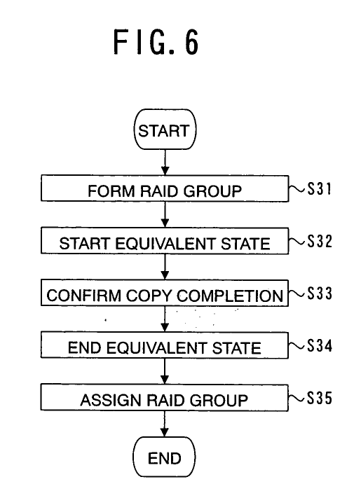

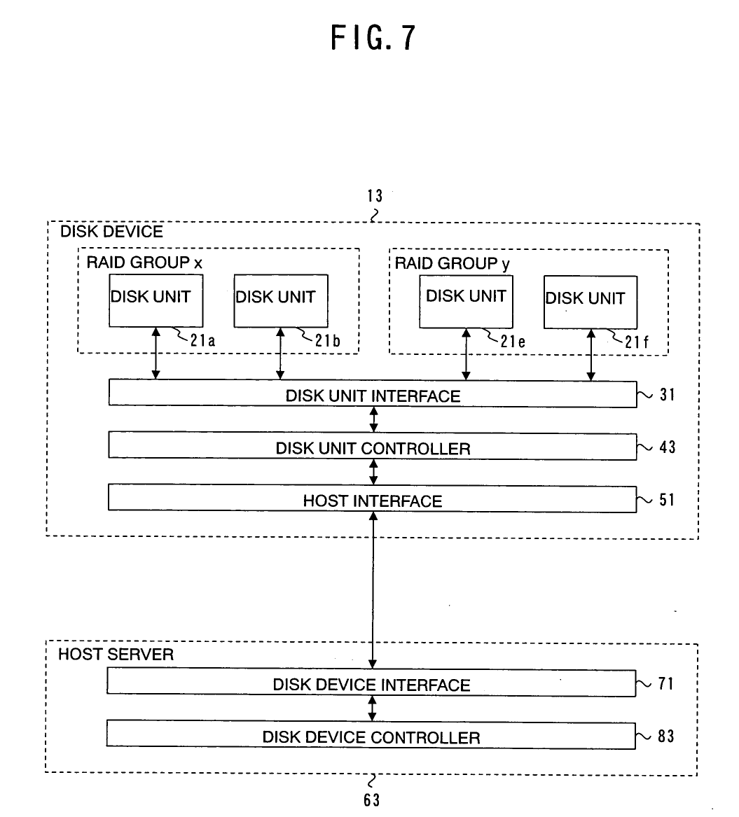

Then, an operation of the disk device controller 83 for the third case will be described. FIG. 6 is a flowchart showing one example of an operation of a disk device controller for the third case according to the present invention. Here, the disk units 21a and 21b are set as a RAID group x. First, when the disk units 21e and 21f for replacement are increased to the disk unit interface 31, the disk device controller 83 designates the disk unit controller 41, and newly forms a RAID group y having the disk units 21e and 21f (S31). The structure at this time is shown in FIG. 7.

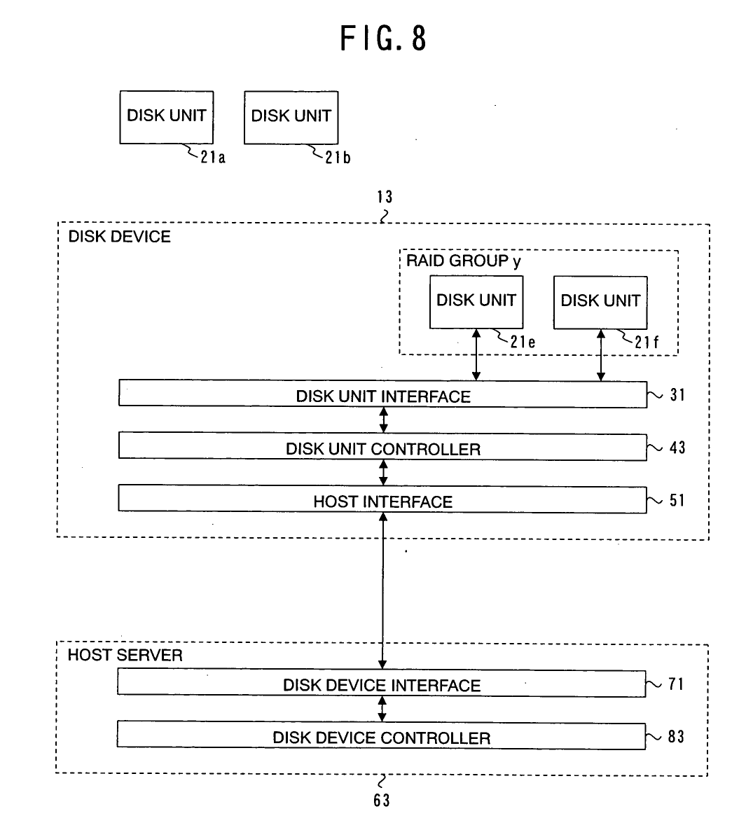

Then, the disk device controller 83 designates the disk unit controller 41, and starts the equivalent state so that the RAID group y becomes equivalent to the RAID group x by using the equivalent copying function of the disk unit controller 41 (S32). Then, when the disk device controller 81 confirms the copy completion (S33), the disk device controller 81 designates the disk unit controller 41 to end the equivalent state (S34). Then, the disk device controller 83 designates the disk unit controller 41, and assigns that the host server 63 uses the RAID group y (S35). Thereafter, the manager can remove the disk units 21a and 21b from the disk device 13, and the host server 63 can use the RAID group y of the disk device 13. The structure at this time is shown in FIG. 8.

According to this embodiment, when a plurality of the disk units are preventively replaced, a plurality of new disk units are mounted at once and copied at once, and a plurality of old disk units are removed at once. Thus, labor, time and risk can be remarkably reduced. Further, a hot spare disk device which has been required in a conventional preventive replacement is not required.

Incidentally, the number of the disk units in the RAID group x and the RAID group y are set two. However, three or more may be used, and one disk unit may be used instead of the RAID group.

In the copy from the RAID group x to the RAID group y, an instantaneous copying function may be used instead of the equivalent copying function. In this case, the disk unit controller 41 has an instantaneous copying function of copying the instantaneous data of the RAID group of the copying source in the RAID group.

Furthermore, a program for allowing a computer constituting the disk device controller to execute the above-mentioned respective steps can be provided as a disk device control program. The above-mentioned program is stored in a recording medium readable by the computer, and thus can be executed by the computer constituting the disk device controller. Here, as the recording medium readable by the computer, an internal storage unit to be internally mounted in a computer such as a ROM and a RAM, a portable storage medium such as a CD-ROM, a flexible disk, a DVD disk, a magneto-optic disk, an IC card, etc., a database for holding a computer program, or other computer as well as its database, and further a transmission medium in a channel, etc., are included.

Incidentally, the disk group forming step means processes S11, S21, S31 in the embodiments. The copy state starting step is processes S12, S22, and S32 in the embodiments. The data building step is a process S13 in the embodiment. The boot environment building step is S23 in the embodiment. The copy state ending step is processes S15, S25 and S34 in the embodiments. Further, the disk group setting step is processes S16, S26 and S35 in the embodiments.

What is claimed is:

1. A disk device control program for allowing a computer to execute a disk device control method for controlling a disk device having a plurality of disk units, and a disk unit controller for forming disk groups having at least a disk unit according to a designation from an external unit and performing a copy state between the disk groups, the program comprising:
a disk group forming step that forms a plurality of disk groups in the disk unit controller;
a copy state starting step that starts a copy state between the plurality of disk groups in the disk unit controller; and
a disk group setting step that sets the plurality of disk groups.

2. The disk device control program according to claim 1, wherein the disk groups are RAID groups for applying RAID to the constituent disk unit.

3. The disk device control program according to claim 2, wherein
the copy state starting step starts an equivalent state to copy so that the disk group of the copying destination is equivalent to the disk group of the copying source as the copy state;
further, between the copy state starting step and the disk group setting step,
a data building step that builds data in the disk group of the copying source in the equivalent state,
a copy state ending step that allows the disk unit controller to end the equivalent state after the copy is completed in the equivalent state,
are executed by the computer,
and the disk group setting step sets mirroring using the plurality of disk groups as the setting.

4. The disk device control program according to claim 2, wherein
the copy state starting step starts the equivalent state to copy so that the disk group of the copying destination is equivalent to the disk group of the copying source as the copy state,
further, between the copy state starting step and the disk group setting step,
a boot environment building step that builds a boot environment in the disk group of the copying source in the equivalent state,
a copy state ending step that allows the disk unit controller to end the equivalent state after the copy is completed in the equivalent state,
are executed by the computer,
and the disk group setting step sets for a plurality of external hosts to independently use the plurality of disk groups as the setting.

5. The disk device control program according to claim 2, wherein
the disk group forming step allows the disk unit controller to form a disk group in use of the disk group having a disk unit in use as the disk group, and allows the disk unit controller to form a disk group for replacement of the disk group having the disk unit for replacement when the disk unit for replacement is connected to the disk unit controller,
the copy state starting step allows the disk unit controller to start an equivalent state to copy so that a copying destination that is the disk group for replacement is equivalent to a copying source that is disk group in use as the copy state,
further, between the copy state starting step and the disk group setting step,
the copy state ending step that allows the disk unit controller to end the equivalent state is executed by the computer after the completion of the copy of the equivalent state,
the disk group setting step sets to use the disk group for replacement as the setting.

6. The disk device control program according to claim 2, wherein
Further, between the disk group forming step and the copy state starting step,
the boot environment building step that builds the boot environment in one disk group of the plurality of disk groups is executed by the computer,
the copy state starting step starts copying of data in other disk group from the disk group building the boot environment by the boot environment building step as the copy state, and
the disk group setting step sets for a plurality of external hosts to independently use the plurality of disk groups as the setting after the copy is completed.

7. The disk device control program according to claim 2, wherein the disk group forming step allows the disk unit controller to form a disk group in use of a disk group having a disk unit in use, and when a disk unit for replacement is connected to the disk unit controller, allows the disk unit controller to form a disk group for replacement of the disk group made of the disk unit for replacement,
the copy state starting step starts copying of data in the disk group for replacement from the disk group in use, and
the disk group setting step sets to use the disk group for replacement as the setting after the copy is completed.

8. A disk device control method for controlling a disk device having a plurality of disk units, and a disk unit controller for forming disk groups having at least one disk unit according to an external designation and performing a copy state between the disk groups, the method comprising:
a disk group forming step that allows the disk unit controller to form a plurality of disk groups,
a copy state starting step that allows the disk unit controller to start a copy state between the plurality of disk groups, and
a disk group setting step that sets the plurality of disk groups.

9. The disk device control method according to claim 8, wherein the disk groups are RAID groups for applying RAID to the constituent disk unit.

10. The disk device control method according to claim 9, wherein
the copy state starting step starts an equivalent state to copy so that the disk group of the copying destination is equivalent to the disk group of the copying source as the copy state,
further, between the copy state starting step and the disk group setting step,
a data building step that builds data in the disk group of the copying source in the equivalent state,
a copy state ending step that allows the disk unit controller to end the equivalent state after the copy is completed in the equivalent state,
are executed by the computer,
and the disk group setting step sets mirroring using the plurality of disk groups as the setting.

11. The disk device control method according to claim 9, wherein
the copy state starting step starts an equivalent state to copy so that the disk group of the copying destination is equivalent to the disk group of the copying source as the copy state,
further, between the copy state starting step and the disk group setting step,
a boot environment building step that builds a boot environment in the disk group of the copying source in the equivalent state,
a copy state ending step that allows the disk unit controller to end the equivalent state after the copy is completed in the equivalent state,
are executed by the computer,
and the disk group setting step sets for a plurality of external hosts to independently use the plurality of disk groups as the setting.

12. The disk device control method according to claim 9, wherein
the disk group forming step allows the disk unit controller to form the disk group in use of a disk group having a disk unit in use, as the disk group, and when a disk unit for replacement is connected to the disk unit controller, allows the disk unit controller to form a disk group for replacement of the disk group made of the disk unit for replacement,
the copy state starting step allows the disk unit controller to start an equivalent state to copy so that a copying destination that is the disk group for replacement is equivalent to a copying source that is the disk group in use as the copy state,
further, between the copy state starting step and the disk group setting step,
the copy state ending step that allows the disk unit controller to end the equivalent state after the completion of the copy of the equivalent state, is executed by the computer, and
the disk group setting step sets to use the disk group for replacement as the setting.

13. The disk device control method according to claim 9, wherein
further, between the disk group forming step and the copy state starting step,
the boot environment building step that builds the boot environment in one disk group of the plurality of disk groups is executed by the computer,
the copy state starting step starts copying of data in other disk group from the disk group in which the boot environment is built in the boot environment building step as the copy state, and
the disk group setting step sets for a plurality of external hosts to independently use the plurality of disk groups as the setting after the copy is completed.

14. A disk control device control system for controlling a plurality of disk devices, comprising:
a plurality of disk units,
a disk unit controller that forms disk groups having at least one disk unit and performing a copy state between the disk groups, and
a disk device controller that allows the disk unit controller to form a plurality of disk groups, and to start a copy state between the plurality of disk groups, and setting the plurality of disk groups.

15. The disk device control system according to claim 14, wherein the disk groups are RAID groups for applying RAID to the constituent disk unit.

16. The disk device control system according to claim 15, wherein the disk device controller starts an equivalent state to copy so that the disk group of the copying destination is equivalent to the disk group of the copying source, builds data in the disk group of the copying source in the equivalent state, allows the disk unit controller to end the equivalent state after the copy is completed in the equivalent state, and sets mirroring using the plurality of disk groups as the setting.

17. The disk device control system according to claim 15, wherein the disk device controller starts an equivalent state to copy so that the disk group of the copying destination is equivalent to the disk group of the copying source as the copy state, builds a boot environment in the disk group of the copying source in the equivalent state, allows the disk unit controller to end the equivalent state after the copy is completed in the equivalent state, and sets for a plurality of external hosts to independently use the plurality of disk groups as the setting.

18. The disk device control system according to claim 15, wherein the disk device controller allows the disk unit controller to form a disk group in use of the disk group having a disk unit in use as the disk group, to form a disk group for replacement of the disk group having a disk unit for replacement when the disk unit for replacement is connected to the disk unit controller, to start an equivalent state to copy so that a copying destination that is the disk group for replacement is equivalent to a copying source that is the disk group in use, as the copy state, and to end the equivalent state after the completion of the copy of the equivalent state, and as the setting, sets to use the disk group for replacement.

19. The disk device control system according to claim 15, wherein the disk device controller forms the disk group, then builds the boot environment in one disk group of the plurality of disk groups, as the copy state, starts copying of data in the other disk group from the disk group in which the boot environment is built in the boot environment building step, and after the copy is completed, as the setting, sets for a plurality of external hosts to independently use the plurality of disk groups.

20. The disk device control system according to claim 15, wherein the disk device controller allows the disk unit controller to form a disk group in use of the disk group having a disk unit in use as the disk group, and to form a disk group for replacement of the disk group having a disk unit for replacement when the disk unit for replacement is connected to the disk unit controller, as the copy state, starts copying of data in the disk group for replacement from the disk group in use, and sets, after the copy is completed, as the setting, to use the disk group for replacement.
